(19) United States
(12) Patent Application Publication
(10) Pub. No.: US 2023/0073509 A1
(43) Pub. Date: Mar. 9, 2023

(54) ELECTROCHEMICAL SYNTHESIS OF AMMONIA USING SEPARATION MEMBRANE AND IONIC LIQUID

(71) Applicant: Lawrence Livermore National Security, LLC, Livermore, CA (US)

(72) Inventors: Maira Ceron Hernandez, Brentwood, CA (US); Hannah Violet Eshelman, Dublin, CA (US); Vedasri Vedharathinam, Fremont, CA (US); Marissa Wood, Oakland, CA (US)

(21) Appl. No.: 17/469,678

(22) Filed: Sep. 8, 2021

(51) Int. Cl. C25B 13/08; C25B 1/27; C25B 1/50; C25B 9/19; C25B 13/07; C25B 15/08; B01D 53/02

(52) U.S. Cl. CPC C25B 13/08; C25B 1/27; C25B 1/50; C25B 9/19; C25B 13/07; C25B 15/08; B01D 53/02; B01D 2256/10; B01D 2257/104; B01D 2257/80

(57) ABSTRACT

In one embodiment, a system includes a purification stage configured to purify an input gas stream prior to delivering the input gas stream to a reaction stage; and a collection stage configured to collect at least some ammonia from the reaction stage. The reaction stage is configured to reduce nitrogen into nitride; and convert at least some of the nitride into ammonia. In another embodiment, a separation membrane includes: an anode; a cathode electrically coupled to the anode; and a porous support material positioned between the anode and the cathode. The separation membrane is configured to reduce nitrogen into nitride; and facilitate hydrogenation of the nitride to form ammonia. In another embodiment, a method includes delivering an input gas stream comprising nitrogen to a separation membrane; reducing at least some of the nitrogen into nitride; and reacting at least some of the nitride with hydrogen-containing compound(s).

This invention was made with Government support under Contract No. DE-AC52-07NA27344 awarded by the United States Department of Energy. The Government has certain rights in the invention.

### FIELD OF THE INVENTION

The present invention relates to ammonia synthesis, and more particularly to synthesis of ammonia using a separation membrane and ionic liquid(s).

### BACKGROUND

Ammonia (NH₃) is the most widely manufactured chemical in the world, and is widely used as a fertilizer, among other applications. Recently, ammonia has been recognized as a carbon-neutral liquid fuel, as ammonia exhibits an energy density of about 4.25 kWh/L, i.e., about 35% higher than that of the traditionally-envisioned carbon-neutral fuel liquid hydrogen.

However, conventional ammonia synthesis is inefficient, and/or requires large input energy (temperature, pressure).

For instance, conventional chemical synthesis proceeds according to the well-known “Haber-Bosch” pathway, in which gaseous molecular nitrogen (N_{2(g)}) and gaseous molecular hydrogen (H_{2(g)}) are reacted in presence of a catalyst to produce ammonia. This reaction requires large input energy, as the reaction only occurs at high pressure (100 barr or more) and temperature (400° C. or more). These high input energy requirements reduce overall energy yield as well as render the process incompatible with current desire for modular, intermittent technologies.

More recently, electrochemical synthesis of ammonia has been demonstrated without requiring as much input energy as the Haber-Bosch process, e.g., temperatures of about 100° C., but these approaches demonstrate low coulombic efficiency (<10%) due to parasitic evolution of hydrogen and low turnover frequency exhibited by requisite catalysts at the lower operating temperatures. As a result, to-date electrochemical synthesis of ammonia has been limited to production flux on the order of about 10 nmol/cm²·s. Commercially viable ammonia synthesis is projected to require production flux approximately two orders of magnitude greater than presently possible using electrochemical synthesis, i.e., about 1,000 nmol/cm²·s (equivalently, 1 μmol/cm²·s).

Efficiency of conventional electrochemical ammonia synthesis, as noted above, is limited in part due to parasitic evolution of hydrogen. This process is governed by an associative mechanism that proceeds according to equations (1)-(3), below. The reaction shown in equation (1) typically occurs at or near the surface of the anode, while the reaction shown in equation (2) most commonly occurs at or near the surface of the cathode.

3H_{2(g)}→6H⁺+6e⁻ (1)

N_{2(g)}+6H⁺→6e⁻+2NH_{3(g)} (2)

6H⁺+6e⁻→3H_{2(g)} (3)

Some electrochemical approaches employ molten salts, typically alkaline halide salts such as lithium chloride/potassium chloride (LiCl/KCl) as electrolyte to reduce/avoid parasitic evolution of hydrogen, but these salts are highly corrosive and are only in liquid form at temperatures of about 450° C. or more. Accordingly, molten salts are not a suitable solution to the efficiency problem associated with conventional electrochemical synthesis, as the corrosive materials and high input energy requirements are incompatible with modular, intermittent production of ammonia, and the process as a whole is at least two orders of magnitude less efficient than required for commercial viability.

Indeed, efficiency and production flux of approaches employing molten salts are also limited by the fact that nitride (N³⁻) ions react with ammonia and water, converting the available nitride into azandiide (NH²⁻) and azanide (NH₂⁻), reducing the available amount of nitride for conversion into ammonia. Electrochemical synthesis of ammonia via molten salt electrolyte mixtures accordingly does not achieve desirable production flux, efficiency, modularity, and intermittency capabilities.

Therefore, it would be useful to provide techniques and systems for synthesizing ammonia at coulombic efficiencies higher than the ˜10% limit and production flow rates greater than 10 nmol/cm²·s, as exhibited by conventional chemical and electrochemical ammonia synthesis techniques.

It would be further advantageous to accomplish such improvements without requiring high input energy/operating conditions characteristic to Haber-Bosch chemistry and electrochemical synthesis (particularly using molten salts).

Further still, it would be beneficial for the improved techniques and systems to exhibit/meet modularity and intermittency conditions suitable for widespread use in modern infrastructure.

### SUMMARY

In one aspect of the invention, a system includes a purification stage configured to purify an input gas stream prior to delivering the input gas stream to a reaction stage; and a collection stage configured to collect at least some ammonia from the reaction stage. The reaction stage is configured to reduce nitrogen into nitride; and convert at least some of the nitride into ammonia.

In another aspect of the invention, a separation membrane includes: an anode; a cathode electrically coupled to the anode; and a porous support material positioned between the anode and the cathode. The separation membrane is configured to reduce nitrogen into nitride; and facilitate hydrogenation of the nitride to form ammonia.

In yet another aspect of the invention, a method for synthesizing ammonia includes delivering an input gas stream comprising nitrogen to a separation membrane; reducing at least some of the nitrogen into nitride; and reacting at least some of the nitride with at least one hydrogen-containing compound to form ammonia.

Other aspects and advantages of the present invention will become apparent from the following detailed description, which, when taken in conjunction with the drawings, illustrate by way of example the principles of the invention.

### BRIEF DESCRIPTION OF THE DRAWINGS

For a fuller understanding of the nature and advantages of the present invention, as well as the preferred mode of use, reference should be made to the following detailed description read in conjunction with the accompanying drawings.

FIG. 1 is a simplified schematic of an exemplary ammonia synthesis system employing a separation membrane and ionic liquid(s), in accordance with the presently described inventive concepts.

FIG. 2 is a simplified schematic of a separation membrane suitable for modular, intermittent, efficient ammonia synthesis, according to various implementations of the inventive concepts disclosed herein.

FIG. 3 is a flowchart of a method, according to one aspect of the presently disclosed inventive concepts.

FIGS. 4A-4D are simplified drawings of chemical structures for exemplary ionic liquids, according to various embodiments of the presently disclosed inventive concepts.

### DETAILED DESCRIPTION

The following description is made for the purpose of illustrating the general principles of the present invention and is not meant to limit the inventive concepts claimed herein. Further, particular features described herein can be used in combination with other described features in each of the various possible combinations and permutations.

Unless otherwise specifically defined herein, all terms are to be given their broadest possible interpretation including meanings implied from the specification as well as meanings understood by those skilled in the art and/or as defined in dictionaries, treatises, etc.

It must also be noted that, as used in the specification and the appended claims, the singular forms “a,” “an” and “the” include plural referents unless otherwise specified.

For the purposes of this application, “room temperature” is defined as in a range of about 20° C. to about 25° C.

Similarly, “high temperature” is to be understood as referring to temperatures above 300° C.

“High pressure” is to be understood as referring to pressures of about 100 barr or more.

“High input energy” is to be understood as referring to energy associated with creating environmental conditions, including but not limited to high temperature and high pressure as required to synthesize ammonia using the Haber-Bosch process, or high temperature as required to maintain alkaline salts in a molten phase as employed for conventional electrochemical ammonia synthesis.

As also used herein, the term “about” denotes an interval of accuracy that ensures the technical effect of the feature in question. In various approaches, the term “about” when combined with a value, refers to plus and minus 10% of the reference value. For example, a thickness of about 10 nm refers to a thickness of 10 nm±1 nm, a temperature of about 50° C. refers to a temperature of 50° C.±5° C., etc.

Similarly, the phrase “substantially all” is to be understood as referring, in various embodiments, to an amount of at least 95%, at least 98%, at least 99%, at least 99.5%, or at least 99.9%, according to various embodiments.

The terms “modular,” “modularity,” and synonyms thereof, as utilized herein are to be understood as referring to systems and components that are capable of being rapidly deployed “in the field,” e.g., within 24 hours or less, at one or more energy production facilities or other source(s) of nitrogen fuel and/or carbon emissions. Preferably, modular systems/components are characterized by lacking any moving parts, and being less expensive than components (especially components responsible for environmental control and producing input energy requisite for) used in Haber-Bosch systems and techniques. Moreover, modular systems and components are capable of being removed and/or replaced. For example, in the event of a malfunctioning component or system, such as an electrode, the component/system may be removed and replaced without substantial interruption to overall system operation.

“Intermittent,” “intermittency,” and synonymous terminology presented herein shall be understood as referring to systems, and components thereof, that are capable of operating without access to a constant/reliable input energy source, as is required for conventional Haber-Bosch ammonia synthesis. For instance, in preferred approaches intermittent systems/components are capable of operating using only energy generated by renewable sources as input.

In one general aspect of the invention, a system includes a purification stage configured to purify an input gas stream prior to delivering the input gas stream to a reaction stage; and a collection stage configured to collect at least some ammonia from the reaction stage. The reaction stage is configured to reduce nitrogen into nitride; and convert at least some of the nitride into ammonia.

In another general aspect of the invention, a separation membrane includes: an anode; a cathode electrically coupled to the anode; and a porous support material positioned between the anode and the cathode. The separation membrane is configured to reduce nitrogen into nitride; and facilitate hydrogenation of the nitride to form ammonia.

In yet another general aspect of the invention, a method for synthesizing ammonia includes delivering an input gas stream comprising nitrogen to a separation membrane; reducing at least some of the nitrogen into nitride; and reacting at least some of the nitride with at least one hydrogen-containing compound to form ammonia.

Advantageously, the inventive systems, membranes, and methods described herein enable more efficient ammonia production, at lower input energy, than conventional chemical and electrochemical synthesis techniques. In preferred embodiments, the presently disclosed inventive concepts exhibit ammonia production flow rates of at least about 50 nmol/cm²·s and coulombic efficiency on the order of about 70%.

The inventive concepts presented herein facilitate higher production of ammonia, relative to conventional techniques, via use of a membrane electrode assembly (MEA) including a porous support matrix with ionic liquid disposed therein. The separation membrane is configured to convert molecular nitrogen into nitride ions, and to facilitate subsequent conversion of the nitride ions to form ammonia, preferably via hydrogenation.

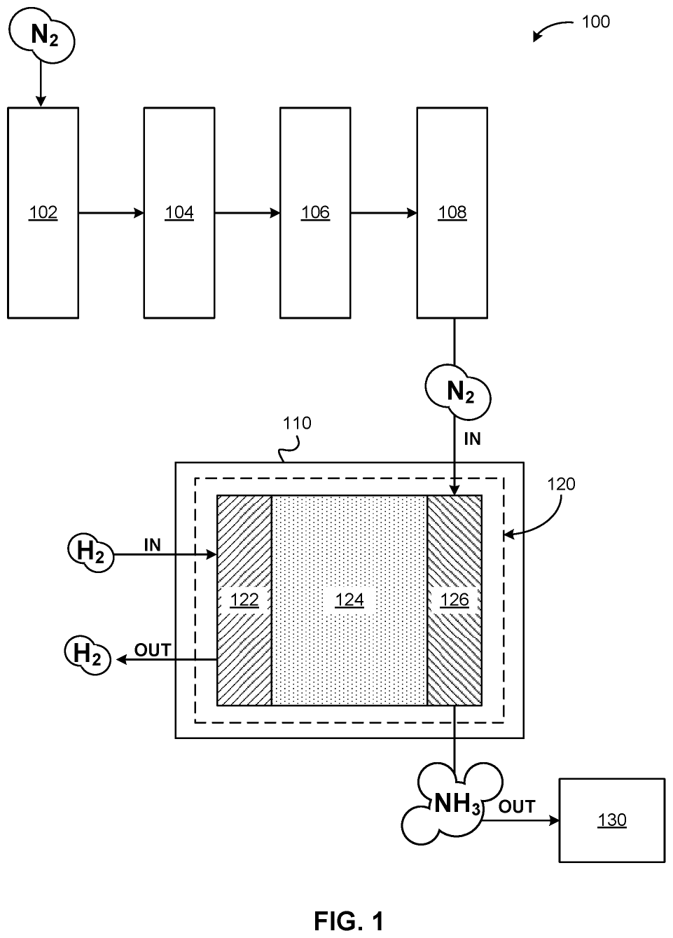

In accordance with an exemplary implementation of the presently disclosed inventive concepts, FIG. 1 shows a simplified schematic of a system 100 for synthesizing ammonia. Advantageously, the system as shown in FIG. 1 is operable at room temperature (about 20-25° C.) or above, but remaining below the “high input energy” requirements (e.g., 400° C. or more) associated with conventional Haber-Bosch ammonia synthesis and conventional electrochemical ammonia synthesis (e.g., using molten salts) as described hereinabove and as would be understood by a person having ordinary skill in the art upon reading the present disclosure.

As shown in FIG. 1, the system 100 comprises three stages. A first stage is configured to purify input gas(es) prior to introduction to the second stage, which is configured to convert at least molecular nitrogen into nitride (N³⁻) ions and. Finally, the third stage is configured to react said nitride ions to form ammonia, and optionally to collect and/or store the produced ammonia.

Again, as shown in FIG. 1, the first stage (a.k.a. purification stage) includes one or more purification elements such as an adsorbent 102, an oxygen scrubber 104, a water scrubber 106, and (optionally) a mass flow controller 108 to measure flow of input gas(es) to the second stage.

The adsorbent element 102 preferably is or comprises copper, e.g., a copper adsorbent, and is configured to purify nitrogen gas from a source (not shown) prior to introduction into the second stage. Namely, the adsorbent element 102 preferably includes suitable compound(s) to adsorb or otherwise remove all or substantially all impurities (e.g., to remove at least 95%, at least 98%, at least 99%, at least 99.5%, or at least 99.9% of impurities), according to various embodiments) such as hydrocarbons, carbon monoxide, sulfur-containing compounds (particularly sulfur dioxide), and other contaminants from the input gas, especially contaminants that would poison catalyst(s) present in the second stage.

Oxygen scrubber 104, in accordance with preferred implementations of the presently described inventive concepts, includes any suitable mechanism, components, compounds, etc. as would be understood by a skilled artisan as suitable to effectively remove all, or substantially all oxygen and/or oxygen-containing species (e.g., at least 95%, at least 98%, at least 99%, at least 99.5%, or at least 99.9% oxygen and/or oxygen-containing species, according to various embodiments), including but not limited to carbon oxide(s) (e.g. CO, CO₂), sulfur oxide(s) (e.g. SO, SO₂, SO₃, SO₄), and/or nitrogen oxide(s) (e.g. NO, NO₂, NO₃).

Oxygen scrubber 104 preferably also includes any suitable mechanism, components, compounds, etc. as would be understood by a skilled artisan as suitable to effectively remove all, or substantially all other oxygen-containing impurities (e.g., at least 95%, at least 98%, at least 99%, at least 99.5%, or at least 99.9%, of oxygen-containing impurities, according to various embodiments) from the input gas stream N₂ IN prior to being delivered to the second stage.

With continuing reference to FIG. 1, the purification stage of system 100 includes a water scrubber (or, equivalently, a water removal component) 106. As noted above regarding electrochemical synthesis employing molten salts such as LiCl/KCl, nitride ions formed during the synthesis reaction may undesirably be converted into azandiide (NH²⁻) and/or azanide (NH₂⁻), reducing the amount of nitride ultimately available for conversion into ammonia, and reducing overall production flux/efficiency. Accordingly, the presently described inventive systems preferably include a water scrubber 106 having any component(s), compound(s), etc. that a skilled artisan would understand as necessary to effectively remove all, or substantially all water (e.g., at least 95%, at least 98%, at least 99%, at least 99.5%, or at least 99.9%, according to various embodiments) from the input gas stream N₂ IN prior to delivery to the second stage of system 100.

Optionally, but preferably, the purification stage also includes a mass flow controller 108 to measure flow of input gas(es) to the second stage. The mass flow controller is particularly useful to measure efficiency of converting input nitrogen (N₂) into ammonia, and ensure the source of the ammonia produced is indeed the input nitrogen rather than other potential sources such as ambient ammonia, oxide gases of nitrogen present in the input gas stream N₂ IN, etc. as would be understood by a person having ordinary skill in the art upon reading the present disclosure. Any mass flow controller, or equivalent thereof, may be employed as element 108 without departing from the scope of the inventive concepts presented herein.

In embodiments where no mass flow controller or other equivalent thereof is employed as element 108, the input gas stream N₂ IN may be provided directly from the water scrubber 106 to the enclosure 110.

Alternatively, since elements 102, 104, and 106 may be positioned in any order/configuration, input gas stream N₂ IN may be provided from any one of: the adsorbent 102, the oxygen scrubber 104, or the water scrubber 106, so long as the input gas stream passes through all three elements prior to being fed into the second stage.

In further alternative approaches, where a pure (i.e., 100% N_{2(g)}) or substantially pure (i.e. ≥99% N_{2(g)}, ≥99.5% N_{2(g)}, ≥99.9% N_{2(g)}, or ≥99.99% N_{2(g)}, according to various embodiments) source of molecular nitrogen gas is available and provided as input gas stream N₂ IN, at least elements 102, 104, and 106 may be omitted from the system 100 without departing from the scope of the inventive concepts discussed herein. However, even where the source of molecular nitrogen is, or is believed to be pure/substantially pure, system 100 preferably includes at least elements 102, 104, and 106 to ensure purity of the input gas stream N₂ IN upon introduction into enclosure 110.

The second stage (a.k.a. reaction stage) of system 100 includes an environmentally controlled enclosure 110 and a separation membrane 120. Preferably, the environmentally controlled enclosure is configured, internally or via external (optionally independently controlled) components, to control at least temperature and humidity within the volume thereof. Any suitable mechanism for controlling temperature and humidity as would be known to skilled artisans upon reading these descriptions may be employed, in various embodiments, without departing from the scope of the presently disclosed inventive concepts.

More preferably, the enclosure 110 is configured to maintain an internal operating temperature in a range from about room temperature (20-25° C.) to at least about 300° C. It shall be understood that, unless otherwise noted, reactions described herein for converting molecular nitrogen into nitride occur at a temperature within a range from about room temperature (20-25° C.) to about 300° C. In this manner, the presently disclosed inventive approaches and systems advantageously avoid the need for high input energy associated with conventional ammonia synthesis.

In one embodiment, enclosure 110 comprises an oven. In more embodiments, enclosure 110 comprises a heater. In still more embodiments, enclosure 110 comprises a fan, and/or an exhaust. In additional embodiments, enclosure 110 comprises a desiccant and/or a humectant. In various embodiments, enclosure 110 may include any component, or combination of components, that a skilled artisan would understand, upon reading the instant descriptions, as suitable for providing temperature and/or humidity control within the internal volume of the enclosure.

In more embodiments, enclosure 110 may be coupled to external components such as described above to provide temperature and/or humidity control within the internal environment of the enclosure. Additionally or alternatively, other components suitable for providing environmental control may be employed as or with enclosure 110, such as an external column or column(s) containing appropriate desiccant(s), humectant(s), and/or other purifying/environmental control agent(s), as would be understood as suitable for providing environmental control over enclosure 110 by a person having ordinary skill in the art upon reading the present disclosures. For instance, in several approaches one or more external columns including DRIERITE®, ZEOLITE®, combinations and/or equivalents thereof, may be employed in, with, or as enclosure 110.

The separation membrane 120 included in the second stage of the inventive ammonia synthesis system 100, according to exemplary embodiments, is positioned within the enclosure 110, and includes at least an anode 122, a cathode 126, and a separation matrix 124 positioned therebetween.

Anode 122 and cathode 126 may comprise any material that would be appreciated by a skilled artisan as suitable for use as an electrode in a membrane electrode array including a separation matrix 124. In preferred embodiments, anode 122 and/or cathode 126 may each independently comprise one or more materials such as carbon paper, iron, molybdenum, platinum, platinum/carbon, platinum/iridium, ruthenium, rhodium, silver, etc. Preferably, the anode 122 and cathode 126 composition is configured such that the anode 122 and/or cathode 126 act as electrolytic catalysts for reducing nitrogen to nitride under operating conditions maintained by the enclosure 110.

The separation matrix 124 comprises a porous support material. Moreover, the porous support material is preferably characterized by a melting temperature above the operating temperature necessary to solubilize nitrogen gas in an ionic liquid disposed in the pores of the porous support material, and convert the nitrogen into nitride. In various embodiments, the porous support material is characterized by a melting temperature greater than about 20° C., a melting temperature greater 300° C., or an even higher melting temperature. Again, the melting temperature for a given embodiment of separation matrix 124 exceeds the operating temperature required to: (a) solubilize nitrogen gas in an ionic liquid disposed in the pores of the porous support material, and (b) convert solubilized nitrogen into nitride.

Additionally, the porous support material preferably comprises a material that does not chemically react with the ionic liquid to be utilized for ammonia synthesis. In various embodiments, porous support material may comprise: one or more ceramics, one or more cermets, one or more metals, one or more alloys, one or more aerogels, one or more xerogels, one or more polymers, etc., and combinations thereof, as would be understood by a person having ordinary skill in the art upon reading the present disclosure. Preferably, the porous support material is non-conductive. In accordance with several exemplary embodiments, the porous support material comprises yttria-stabilized zirconia (YSZ), alumina (Al₂O₃), ceria (CeO₂), or any permutation/combination thereof.

With continuing reference to separation matrix 124, the pores of the porous support material preferably exhibit an average pore diameter that is sufficiently small to allow ionic liquid(s), nitrogen, and nitride disposed therein to be transported across the porous support material via capillary action. For instance, in various embodiments, the pores of porous support material may exhibit an average diameter in a range from about 20 nm to about 200 nm. Particularly preferred embodiments of the porous support material are characterized by an average pore diameter of about 100 nm.

As will be appreciated by those having ordinary skill in the art upon reading the present disclosure, the efficiency of the separation membrane 120 is a function of path length (which in turn is a function of thickness) of the separation matrix 124. Accordingly, preferred embodiments of separation membrane 120 include a separation matrix 124 characterized by a thickness sufficient to convey sufficient structural stability to perform separation, but otherwise being as thin as possible to facilitate ionic conductivity, e.g., a thickness in a range from about 100 μm to about 2.5 mm, or a thickness in a range from about 200 μm to about 2.0 mm, according to various embodiments. According to preferred embodiments, separation membrane 120 employs a separation matrix 124 having a thickness of in a range from about 100 μm to about 500 μm, and in one particularly preferred embodiment separation matrix 124 is characterized by a thickness of about 300 μm.

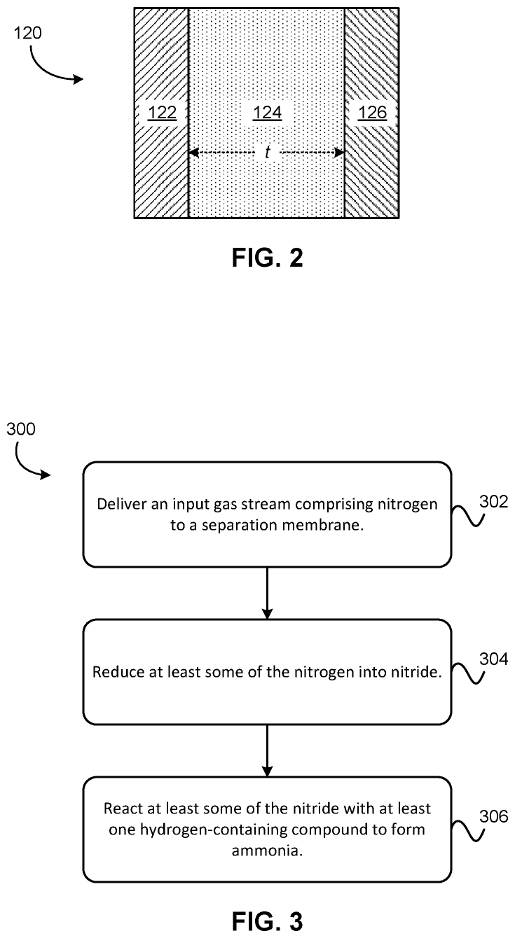

As shown in FIG. 2, the thickness t of the separation matrix 124 is/corresponds to the distance between the anode 122 and cathode 126.

In use, the separation matrix 124 also includes at least one ionic liquid disposed in at least the pores of the porous support material. Preferably, the ionic liquid(s) exhibit high solubility for nitrogen gas at temperatures ranging from about 20° C. to about 300° C., and ambient pressure. Further still, preferable ionic liquid(s) exhibit a high ionic conductivity at temperatures ranging from about 20° C. to about 300° C., and ambient pressure. Additionally, the ionic liquids preferably do not include any nitrogen, in order to ensure all ammonia that is synthesized originates from the input nitrogen.

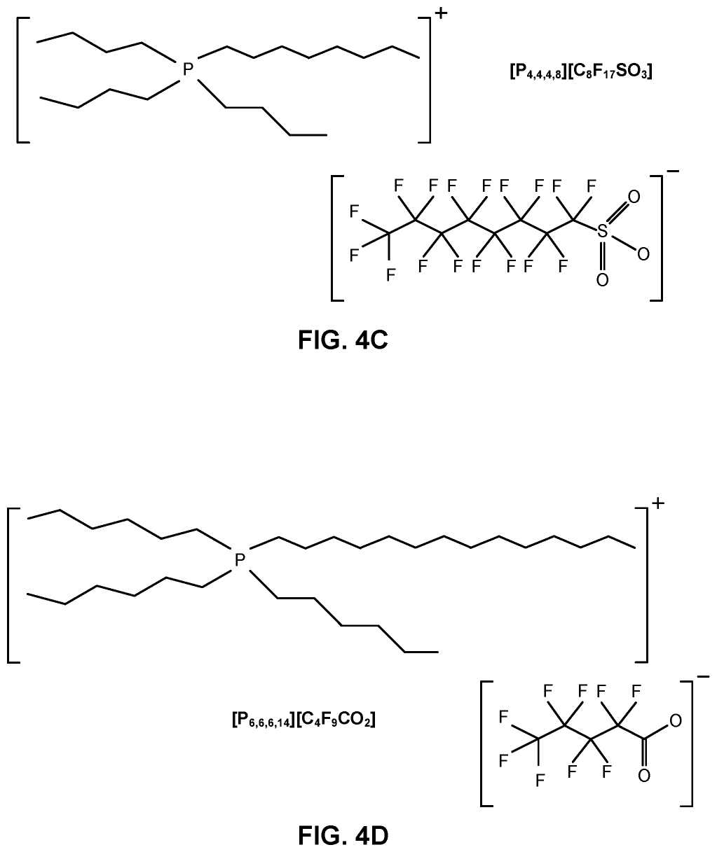

More preferably, the ionic liquid(s) include fluorine, i.e., are fluorinated ionic liquids. In particularly preferred embodiments, the ionic liquid(s) may include any single member or combination of: 1-butyl-1-methylpyrrolidinium trifluorotris(perfluoroethyl)phosphate(V) (also referred to herein “[C₄mpyr][eFAP]”), (tetradecyl)phosphonium trifluorotris(perfluoroethyl)phosphate(V) (also referred to herein “[P_{6,6,6,14}][eFAP]”), trihxyltetradecylphosphonium hepadecaflurouooctane-1-sulfonate (also referred to herein “[P_{4,4,4,8}][C₈F₁₇SO₃]”), and/or trihexyltetradecylphosphonium nonafluoropentanoate (also referred to herein as “[P_{6,6,6,14}][C₄F₉CO₂]”), the chemical structures of which are respectively shown in FIGS. 4A-4D.

In operation, the separation membrane 120 solvates molecular nitrogen introduced into the enclosure 110 via the ionic liquid(s) disposed in the separation matrix, which may optionally be facilitated with heat (at temperatures from about 20° C. to about 300° C., in various approaches) depending upon the solubility of nitrogen in the ionic liquid, the desired production flow rate, and the thermal stability of the ionic liquid(s) being used. Notably, as the separation membrane operates via electrochemical reduction, the presently disclosed inventive ammonia synthesis system 100 does not require application of pressure to generate ammonia.

The ionic liquid(s) are also preferably characterized by high selectivity for a nitrogen reduction reaction (NRR) that converts molecular nitrogen into nitride within the separation matrix 124 via cyclic voltammetry, which is followed by hydration of the nitride to form ammonia, e.g., according to a dissociative mechanism as shown in equations (4) and (5), below. The reduction shown in equation (4) occurs at or near surface(s) of the cathode 126 of separation membrane 120, while the hydration reaction shown in equation (5) occurs at or near surface(s) of the anode 122.

N_{2(g)}+6e⁻→2N³⁻ (4)

2N³⁻+3H_{2(g)}→2NH₃+6e⁻ (5)

In alternative embodiments, water may serve as a source of hydrogen for the hydration step of the dissociative mechanism.

In order to avail of the dissociative mechanism, which is characterized by substantially better efficiency (i.e., about 70% coulombic efficiency) than the associative mechanism discussed above regarding conventional electrochemical synthesis of ammonia, a current is preferably applied across the separation membrane 124 via anode 122 and cathode 126.

In addition, a source of hydrogen, preferably molecular hydrogen (as shown in FIG. 1) or water, may be supplied to the enclosure 110 during operation of the system 100 to ensure an excess of available hydrogen for the hydration reaction of equation (5).

By employing a separation membrane 120 with suitable ionic liquid disposed therein, the presently disclosed inventive ammonia synthesis system 100 may exhibit ammonia synthesis flux/current density of about 250 mA/cm² or more; a coulombic efficiency greater than 50%, e.g., about 70% in preferred embodiments; and a production flow of about 50 nmol/cm²·s or more. Notably, the foregoing performance metrics are achieved without requiring high input energy associated with chemical synthesis of ammonia and electrochemical synthesis employing molten salts.

Referring again to FIG. 1, system 100 includes a third (a.k.a. collection) stage 130, which includes any means and/or mechanism that would be understood by a skilled artisan reading the present disclosure as suitable for collecting and storing ammonia gas NH₃ OUT produced by and/or using the system 100.

In one approach, collection stage 130 includes an acid trap having therein a (preferably strong) acid, e.g., 5M HCl, 5M HI, 5M H₂SO₄, 5M HBr, 5M HNO₃, 5M HClO₄, 5M HCLO₃, etc., which advantageously facilitates detection of ammonia and identification of the source from which the ammonia was synthesized. For instance, ammonia produced from molecular nitrogen in the input gas may be distinguished from ammonia produced using nitrogen originating from other sources, such as impurities, oxides of nitrogen, etc. as would be understood by a person having ordinary skill in the art upon reading the instant descriptions.

In another approach, collection stage 130 includes a gas chromatographer upstream of the collection vessel, which advantageously allows characterization of the composition of the output gas (e.g., to detect contaminants, quantify amount of ammonia synthesized, etc. as would be understood by a person having ordinary skill in the art upon reading the present disclosure).

In particularly preferred approaches, system 100 is modular and compatible with intermittent operations. For instance, system 100 may exclude any moving parts, in some approaches. Moreover, system 100 may be operable using only current obtained from renewable energy sources. In such embodiments, system 100 may advantageously be robust to temporary power losses, to the extent of potentially requiring zero input energy (e.g., where the reactions converting nitrogen to nitride, and converting nitride to ammonia, proceed at room temperature).

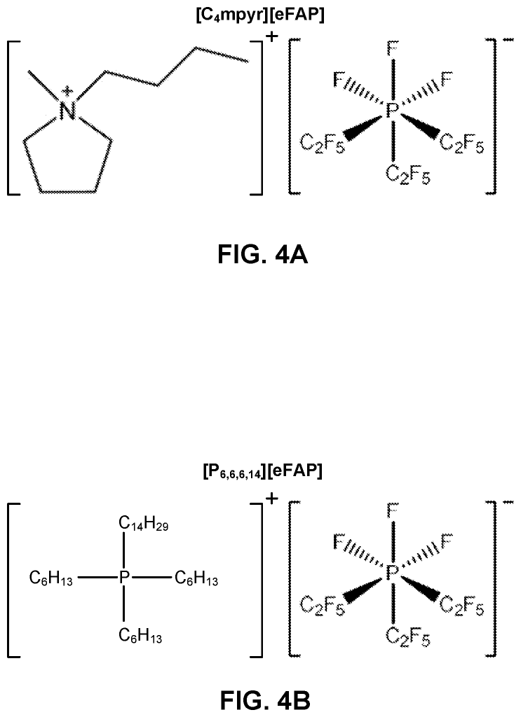

Turning now to methods for ammonia synthesis as described herein, FIG. 3 shows a method 300 for synthesizing ammonia using a separation membrane and ionic liquids, according to one inventive aspect. The method 300 as presented herein may be carried out in any desired environment that would be appreciated as suitable by a person having ordinary skill in the art upon reading the present disclosure. Moreover, more or less operations than those shown in FIG. 3 may be included in method 300, according to various embodiments. It should also be noted that any of the aforementioned features may be used in any of the embodiments described herein, including but not limited to system 100 and/or separation membrane 120 as respectively shown in FIGS. 1 and 2.

As shown in FIG. 3, method 300 includes at least operation 302, where an input gas stream comprising nitrogen is delivered to a separation membrane, e.g., separation membrane 120 as shown in FIGS. 1 and 2. Preferably, the nitrogen is in the form of gaseous molecular nitrogen, and is delivered to the separation membrane enclosed within an environmentally controlled enclosure, e.g. enclosure 110 as shown in FIG. 1.

In operation 304, method 300 continues via reduction of the nitrogen into nitride (N³⁻). Preferably, the reduction occurs at or within the separation membrane, e.g. at or near surface(s) of a cathode, such as cathode 126 as shown in FIGS. 1 and 2. More preferably, the reduction proceeds according to a nitrogen reduction reaction (NRR), facilitated by an ionic liquid disposed in the separation membrane that is highly selective for the NRR and in which nitrogen gas is highly soluble under conditions including a temperature ranging from about 20° C. to about 300° C. and ambient pressure.

Operation 306 of method 300 involves forming ammonia by reacting at least some of the nitride produced in operation 304 with at least one hydrogen-containing compound, e.g., molecular hydrogen and/or water. Preferably, the reaction occurs at or within the separation membrane, e.g., at or near surface(s) of an anode, such as anode 122 as shown in FIGS. 1 and 2.

Of course, method 300 may include any number, combination, or permutation of additional and/or alternative steps, features, etc. beside/beyond those shown in FIG. 3, according to various embodiments.

For instance, in one approach method 300 may include purifying the input gas stream prior to delivering the input gas stream to the separation membrane. Preferably, purifying the input gas stream substantially removes all or substantially all contaminant(s) (e.g., at least 95%, at least 98%, at least 99%, at least 99.5%, or at least 99.9% contaminants, according to various embodiments) such as carbon-containing compounds (particularly oxides of carbon such as carbon monoxide and carbon dioxide); sulfur-containing compounds (again, particularly oxides such as sulfur dioxide); oxygen-containing compounds; hydrazine, ammonia, and/or water.

Of course, other contaminants that would be appreciated by a skilled artisan upon reading the present descriptions may be removed instead of, or in addition to, the foregoing exemplary contaminants, without departing from the scope of the inventive concepts presented herein. In various approaches, purifying the input gas stream may be performed using a purification stage such as shown in, and described herein with reference to, FIG. 1.

In more approaches, method 300 may include applying a current across the separation membrane. Preferably, the current is obtained from/provided by a renewable energy source. Moreover, in various approaches the energy source may be an intermittent energy source. Applying current across the separation membrane assists in driving the dissociative mechanism described hereinabove, improving overall efficiency and production flow rate of ammonia synthesis.

Of course, method 300 may additionally or alternatively include establishing and/or maintaining an operating temperature of the separation membrane during ammonia synthesis, e.g., using an environmentally controlled enclosure such as enclosure 110. While preferred embodiments of the presently disclosed inventive concepts may accomplish ammonia synthesis even at room temperature, increasing the temperature of the separation membrane (and ionic liquid disposed therein) increases the conductivity of the system, which results in increased current and ammonia production. Accordingly, in various approaches the separation membrane, while in use, may be maintained at or near an operating temperature in a range from about 20° C. to about 300° C.

With continuing reference to method 300, the inventive ammonia synthesis technique as described herein is preferably characterized by: a coulombic efficiency of about 50% or more, e.g., about 70%; and being capable of forming ammonia at a flow rate of at least about 50 nmol/cm²·s.

In Use

Various aspects of an invention described herein may be developed for synthesis of ammonia to produce fertilizer, to reduce carbon emissions, etc. as described herein and as would be understood by a person having ordinary skill in the art upon reading the present disclosure.

The inventive concepts disclosed herein have been presented by way of example to illustrate the myriad features thereof in a plurality of illustrative scenarios, aspects of an invention, and/or implementations. It should be appreciated that the concepts generally disclosed are to be considered as modular, and may be implemented in any combination, permutation, or synthesis thereof. In addition, any modification, alteration, or equivalent of the presently disclosed features, functions, and concepts that would be appreciated by a person having ordinary skill in the art upon reading the instant descriptions should also be considered within the scope of this disclosure.

While various aspects of the invention have been described above, it should be understood that they have been presented by way of example only, and not limitation. Thus, the breadth and scope of an aspect of the present invention should not be limited by any of the above-described exemplary aspects of the invention but should be defined only in accordance with the following claims and their equivalents.

What is claimed is:

1. A system, comprising:
a purification stage configured to purify an input gas stream prior to delivering the input gas stream to a reaction stage, wherein the reaction stage is configured to:
reduce nitrogen into nitride, and
convert at least some of the nitride into ammonia; and
a collection stage configured to collect at least some of the ammonia.

2. The system of claim 1, wherein the purification stage comprises:
an adsorbent configured to remove substantially all of one or more impurities from the input gas stream prior to delivering the input gas stream to the reaction stage;
an oxygen scrubber configured to remove substantially all of one or more oxygen-containing compounds from the input gas stream prior to delivering the input gas stream to the reaction stage; and
a water scrubber configured to remove substantially all water from the input gas stream prior to delivering the input gas stream to the reaction stage.

3. The system of claim 1, wherein the reaction stage comprises:
an environmentally-controlled enclosure, and
a separation membrane.

4. The system of claim 3, wherein the separation membrane comprises:
an anode,
a cathode electrically coupled to the anode, and
a separation matrix positioned between the anode and the cathode.

5. The system of claim 4, wherein the separation matrix comprises a porous support material and at least one ionic liquid disposed in some or all pores of the porous support material.

6. The system of claim 5, wherein the at least one ionic liquid comprises a fluorinated ionic liquid.

7. The system of claim 5, wherein the pores of the porous support material are characterized by an average diameter in a range from about 20 nm to about 200 nm.

8. The system of claim 5, wherein the porous support material is characterized by a thickness in a range from about 100 μm to about 2,500 μm.

9. The system of claim 5, wherein the porous support material is characterized by a melting temperature greater than 300° C.

10. The system of claim 5, wherein the porous support material comprises yttria-stabilized zirconia.

11. A separation membrane, comprising:
an anode;
a cathode electrically coupled to the anode; and
a porous support material positioned between the anode and the cathode; and
wherein the separation membrane is configured to:
reduce nitrogen into nitride, and
facilitate hydrogenation of the nitride to form ammonia.

12. The separation membrane of claim 11, comprising a fluorinated ionic liquid disposed in the porous support material.

13. The separation membrane of claim 11, wherein pores of the porous support material are characterized by an average diameter in a range from about 20 nm to about 200 nm.

14. The separation membrane of claim 11, wherein the porous support material is characterized by a thickness in a range from about 100 μm to about 2,500 μm.

15. The separation membrane of claim 11, wherein the porous support material is characterized by a melting temperature greater than 300° C.

16. The separation membrane of claim 11, wherein the porous support material comprises yttria-stabilized zirconia.

17. A method for synthesizing ammonia, the method comprising:
delivering an input gas stream comprising nitrogen to a separation membrane;
reducing at least some of the nitrogen into nitride; and
reacting at least some of the nitride with at least one hydrogen-containing compound to form ammonia.

18. The method of claim 17, comprising purifying the input gas stream prior to
delivering the input gas stream to the separation membrane;
wherein purifying the input gas stream substantially removes therefrom one or more contaminants; and
wherein the one or more contaminants are selected from the group consisting of: carbon-containing compounds, sulfur-containing compounds, oxygen-containing compounds, ammonia, hydrazine, water, and combinations thereof.

19. The method of claim 17, comprising applying a current across the separation membrane.

20. The method of claim 17, comprising establishing and/or maintaining an operating temperature of the separation membrane, wherein the operating temperature is in a range from about 20° C. to about 300° C.

21. The method of claim 17, wherein reducing the nitrogen to the nitride is characterized by a coulombic efficiency of about 50% or more.

22. The method of claim 17, wherein the ammonia is formed at a flow rate of at least about 50 nmol/cm²·s.
